(19) United States
(12) Patent Application Publication
(10) Pub. No.: US 2025/0343004 A1
(43) Pub. Date: Nov. 6, 2025

(54) MULTILAYER CERAMIC CAPACITOR AND METHOD OF MANUFACTURING THE SAME

(71) Applicant: TAIYO YUDEN CO., LTD., Tokyo (JP)

(72) Inventors: Junko SAKASHITA, Takasaki-shi (JP); Ayumi SHIROTA, Takasaki-shi (JP); Atsushi ITO, Takasaki-shi (JP)

(21) Appl. No.: 19/266,711

(22) Filed: Jul. 11, 2025

Related U.S. Application Data
(63) Continuation of application No. PCT/JP2024/003997, filed on Feb. 7, 2024.

(30) Foreign Application Priority Data
Feb. 9, 2023 (JP) 2023-018128

(51) Int. Cl. H01G 4/30; H01G 4/232

(52) U.S. Cl. CPC H01G 4/30; H01G 4/2325

(57) ABSTRACT

A multilayer ceramic capacitor includes a plurality of terminal electrodes containing a metal having nickel as a main component element on the surface of at least one cover layer of a multilayer chip. Each of terminal electrode facing portions has nickel segregation regions each having a maximum dimension of 0.4 μm or more and having a nickel concentration higher than surroundings in an element distribution map generated by measuring a concentration distribution of nickel in any cross section parallel to the lamination direction, and a density of a nickel segregation region having a maximum dimension of 0.5 μm or more in the nickel segregation regions is 0.015 or more per 1 μm². In a terminal electrode non-facing portion, a density of the nickel segregation region having the maximum dimension of 0.5 μm or more is 0.008 or less per 1 μm² in the element distribution map.

### CROSS-REFERENCE TO RELATED APPLICATION

This application is based upon and claims the benefit of priority of the prior International Patent Application No. PCT/JP2024/003997, filed on Feb. 7, 2024, which claims the benefits of priorities of Japanese Patent Application No. 2023-018128 filed on Feb. 9, 2023, the entire contents of which are incorporated herein by reference.

### FIELD

A certain aspect of the present invention relates to a multilayer ceramic capacitor and a method of manufacturing the same.

### BACKGROUND

There has been known a multilayer ceramic capacitor that includes: a multilayer chip in which dielectric layers formed of a dielectric ceramic and internal electrodes composed of a metal as a main component are alternately laminated, the multilayer chip including cover layers formed of a dielectric ceramic at both ends in a lamination direction; a pair of connection conductors formed inside or on a surface of the multilayer chip and alternately connecting the internal electrodes in the lamination direction; and a pair of terminal electrodes formed on one surface of the cover layers and electrically connected to the pair of connection conductors.

Among the multilayer ceramic capacitors having such a structure, a multilayer ceramic capacitor including a conductive metal or an oxide thereof in the cover layers has been reported.

Japanese Laid-Open Patent Publication No. 2019-106443 (hereinafter referred as Patent Document 1) discloses a multilayer ceramic capacitor in which a plurality of diffusion metal portions made of the same metal as the metal included in the internal electrode are disposed in a first main-surface-side outer layer portion and a second main-surface-side outer layer portion corresponding to cover layers.

Japanese Laid-Open Patent Publication No. 2015-226053 (hereinafter referred as Patent Document 2) discloses that, when a multilayer ceramic capacitor is manufactured, peroxidized metal particles are contained in green sheets for forming outer covers corresponding to the cover layers, and thus a multilayer ceramic capacitor including metal particles formed by reduction of the peroxidized metal particles in the cover layers is obtained.

Japanese Laid-Open Patent Publication No. 2003-173925 (hereinafter referred as Patent Document 3) discloses that, when a multilayer ceramic capacitor is manufactured, oxides of conductive metal powders contained in the internal electrodes are contained in advance in ceramic green sheets for forming outer layer portions corresponding to the cover layers.

### SUMMARY OF THE INVENTION

According to a first aspect of the present disclosure, there is provided a multilayer ceramic capacitor including: a multilayer chip in which a plurality of dielectric layers formed of a dielectric ceramic and a plurality of internal electrodes composed of a metal as a main component are alternately laminated, the multilayer chip including a plurality of cover layers formed of a dielectric ceramic at both ends of the multilayer chip in a lamination direction; a plurality of connection conductors formed inside or on a surface of the multilayer chip and that electrically connect the internal electrodes to each other; and a plurality of terminal electrodes formed on at least one surface of the cover layer with a space therebetween, electrically connected to the connection conductors, respectively, each of the plurality of terminal electrodes including a portion in contact with the cover layers, the portion containing a metal containing nickel as a main component element, wherein in a case where portions of the cover layers that overlaps the terminal electrodes when viewed from the lamination direction are defined as a plurality of terminal electrode facing portions, and a portion of the cover layers that does not overlap each of the terminal electrodes when viewed from the lamination direction is defined as a terminal electrode non-facing portion, each of the terminal electrode facing portions has nickel segregation regions each having a maximum dimension of 0.4 μm or more and having a nickel concentration higher than surroundings in an element distribution map generated by measuring a concentration distribution of nickel in any cross section parallel to the lamination direction, and a density of a nickel segregation region having a maximum dimension of 0.5 μm or more in the nickel segregation regions is 0.015 or more per 1 μm², and in the terminal electrode non-facing portion, a density of the nickel segregation region having the maximum dimension of 0.5 μm or more is 0.008 or less per 1 μm² in the element distribution map.

According to a second aspect of the present disclosure, there is provided a multilayer ceramic capacitor including: a multilayer chip in which a plurality of dielectric layers formed of a dielectric ceramic and a plurality of internal electrodes composed of a metal as a main component are alternately laminated, the multilayer chip including a plurality of cover layers formed of a dielectric ceramic at both ends of the multilayer chip in a lamination direction; a plurality of connection conductors formed inside or on a surface of the multilayer chip and that electrically connect the internal electrodes to each other; and a plurality of terminal electrodes formed on at least one surface of the cover layer with a space therebetween, electrically connected to the connection conductors, respectively, each of the plurality of terminal electrodes including a portion in contact with the cover layers, the portion containing a metal containing nickel as a main component element, wherein in a case where portions of the cover layers that overlaps the terminal electrodes when viewed from the lamination direction are defined as a plurality of terminal electrode facing portions, and a portion of the cover layers that does not overlap each of the terminal electrodes when viewed from the lamination direction is defined as a terminal electrode non-facing portion, in each of the terminal electrode facing portions, when an element distribution map generated by measuring a concentration distribution of nickel in any cross section parallel to the lamination direction is divided into square cells each having a side of 5 μm, a number of cells in which a nickel segregation region having a nickel concentration higher than surroundings and having a maximum dimension of 0.4 μm or more is included is 50% or more of a total number of cells, and in the terminal electrode non-facing portion, when the element distribution map is divided into the square cells each having a side of 5 μm, a number of cells in which the nickel segregation region is included is 5% or less of the total number of cells.

According to a third aspect of the present disclosure, there is provided a method of manufacturing the multilayer ceramic capacitor according to the first aspect of the present disclosure, including: preparing a powder of a dielectric ceramic composition; mixing the powder of the dielectric ceramic composition with a binder and molding a mixture into a sheet shape to obtain a green sheet; forming an internal electrode pattern including a metal on the green sheet; laminating a predetermined number of green sheets on which the internal pattern is formed, disposing green sheets for cover layers at both ends of laminated green sheets in a lamination direction, and then pressure-bonding the green sheets for cover layers and the laminated green sheets to obtain an unfired laminated body; cutting the unfired laminated body to obtain an unfired laminated chip; removing the binder from the unfired laminated chip; forming a plurality of metal layers containing nickel as a main component element on a surface of at least one of the green sheets for cover layers in the unfired laminated chip after removal of the binder by a physical vapor deposition method or a thermal spraying method, the plurality of metal layers being spaced from each other; and firing an unfired molded body on which the plurality of metal layers are formed to obtain a sintered body.

### BRIEF DESCRIPTION OF THE DRAWINGS

FIG. 1 is a schematic view (a cross-sectional view in a longitudinal direction) illustrating the structure of a multilayer ceramic capacitor according to a first embodiment.

FIG. 2 is a schematic view (a cross-sectional view in a width direction) illustrating the structure of the multilayer ceramic capacitor according to the first embodiment.

FIG. 3 is a diagram illustrating an example of an element distribution map obtained for a cross section parallel to the lamination direction of a terminal electrode facing portion in the multilayer ceramic capacitor according to the first embodiment.

FIG. 4 is a diagram illustrating an example of an element distribution map obtained for a cross section parallel to the lamination direction of a terminal electrode non-facing portion in the multilayer ceramic capacitor according to the first embodiment.

FIG. 5 is a diagram illustrating a state in which square cells S each having a side of 5 μm are drawn in an element distribution map obtained for a cross section parallel to the lamination direction of the terminal electrode facing portion in the multilayer ceramic capacitor according to a second embodiment.

FIG. 6 is a diagram illustrating a state in which square cells S each having a side of 5 μm are drawn in an element distribution map obtained for a cross section parallel to the lamination direction of the terminal electrode non-facing portion in the multilayer ceramic capacitor according to the second embodiment.

FIG. 7 is a schematic view (a sectional view in a longitudinal direction) illustrating the structure of a first modification of the multilayer ceramic capacitor according to first and second aspects of the present disclosure.

FIG. 8 is a schematic view (a sectional view in a longitudinal direction) illustrating a preferred structure of the first modification of the multilayer ceramic capacitor according to the first and second aspects of the present disclosure.

FIG. 9 is a schematic view (a sectional view in a longitudinal direction) illustrating the structure of a second modification of the multilayer ceramic capacitor according to the first and second aspects of the present disclosure.

FIG. 10A is a schematic view (a sectional view in a longitudinal direction) illustrating the structure of a third modification of the multilayer ceramic capacitor according to the first and second aspects of the present disclosure.

FIG. 10B is a schematic view (a sectional view in a longitudinal direction) illustrating the structure of a third modification of the multilayer ceramic capacitor according to the first and second aspects of the present disclosure.

FIG. 10C is a schematic view (a sectional view in a longitudinal direction) illustrating the structure of a third modification of the multilayer ceramic capacitor according to the first and second aspects of the present disclosure.

FIG. 11 is a schematic view (an overall perspective view) illustrating the structure of a fourth modification of the multilayer ceramic capacitor according to the first and second aspects of the present disclosure.

### DETAILED DESCRIPTION

The multilayer ceramic capacitor having the above-described structure is mounted on a circuit substrate by connecting the terminal electrodes to the circuit substrate. In the multilayer ceramic capacitor mounted on the circuit substrate in this manner, stress is concentrated on the terminal electrodes and the cover layer in contact with the terminal electrodes due to the deflection of the circuit substrate. Therefore, when the multilayer ceramic capacitor having the above-described structure is mounted on a circuit substrate that is expected to be greatly deformed by bending during use, the multilayer ceramic capacitor is required to reduce or prevent the occurrence of cracks in the cover layers and short-circuit failures caused by the cracks that have occurred reaching the internal electrodes.

However, Patent Documents 1 to 3 do not disclose a multilayer ceramic capacitor in which the occurrence of cracks in the cover layers due to the concentration of external stress is suppressed.

In recent years, multilayer ceramic capacitors have been increasingly reduced in size, and accordingly, the cover layers tend to be thinner and the distance between the terminal electrodes tends to be smaller. In the multilayer ceramic capacitors disclosed in Patent Documents 1 to 3, the thinning of the cover layers may cause deposition of a conductive metal on the surfaces of the cover layers, and the narrowing of the intervals between the terminal electrodes may cause short-circuiting between the terminal electrodes via the deposited conductive metal.

It is an object of the present disclosure to provide a multilayer ceramic capacitor and a method of manufacturing the same that can suppress the occurrence of cracks in the cover layer due to the concentration of external stress and can suppress short-circuiting between the terminal electrodes.

The present inventors have conducted various studies to solve the above-described problem. The present inventors have found that, when terminal electrodes or base layer thereof containing a metal containing nickel as a main component element is formed by a physical vapor deposition (PVD) method or a thermal spraying method and then fired in the production of a multilayer ceramic capacitor, a segregation portion of a metal element contained in the terminal electrodes or the base layer thereof is generated in a cover layer facing the terminal electrodes, and thus the occurrence of cracks in the cover layer is suppressed, thereby completing the present disclosure.

Hereinafter, the configuration and the effects of the present disclosure will be described together with the technical idea with reference to the drawings. However, the action mechanism includes presumption, and the correctness or incorrectness thereof does not limit the present disclosure.

### [Multilayer Ceramic Capacitor]

### First Embodiment

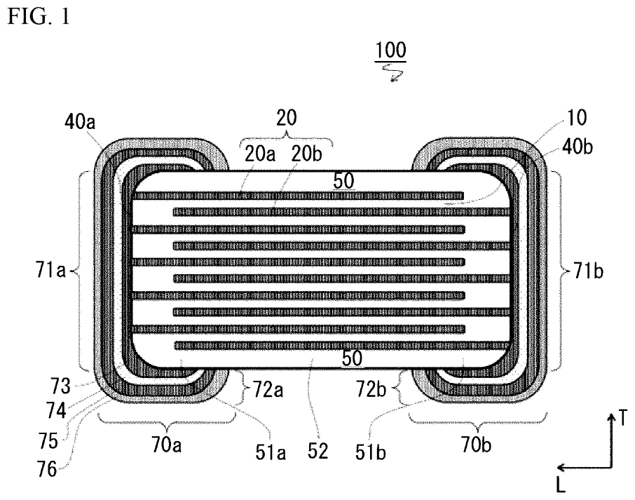

An embodiment of a multilayer ceramic capacitor according to a first aspect of the present disclosure is illustrated in FIG. 1 as a first embodiment. The multilayer ceramic capacitor 100 according to the first embodiment has a rectangular parallelepiped shape and includes a pair of surfaces that are perpendicular or substantially perpendicular to each of three axes that are perpendicular or substantially perpendicular to each other, that is, an L axis that is a length direction, a W axis that is a width direction, and a T axis that is a height direction. The rectangular parallelepiped is not limited to a rectangular parallelepiped defined mathematically, and may be a shape recognized as a rectangular parallelepiped when the entire shape is observed. Therefore, a rectangular parallelepiped having rounded ridges and corners, a rectangular parallelepiped having a curved ridge, and a rectangular parallelepiped having curved surfaces with a small curvature are also included in the rectangular parallelepiped in the present disclosure. The dimensions of the ceramic capacitor 100 in the length (L) direction, the width (W) direction, and the height (T) direction may each independently be any value, and the magnitude relationship of the dimensions is not limited. For example, (the dimension in the L direction)>(the dimension in the W direction)>(the dimension in the T direction) may be satisfied, (the dimension in the W direction)>(the dimension in the L direction) may be satisfied, or (the dimension in the T direction)>(the dimension in the W direction) may be satisfied.

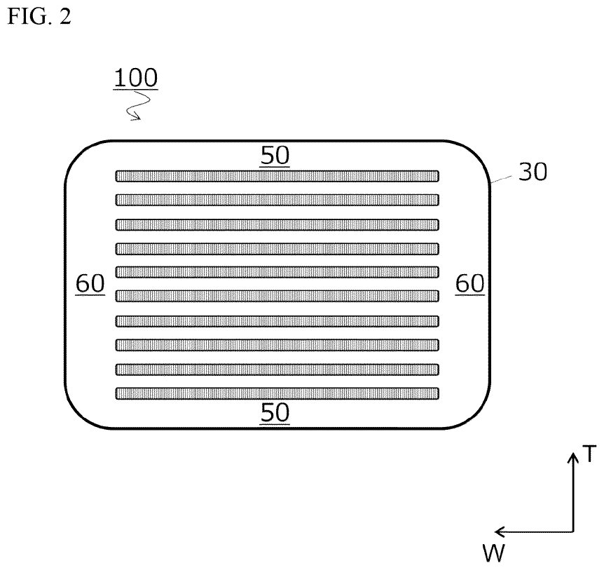

As illustrated in FIG. 1 (LT cross section) and FIG. 2 (WT cross section), a multilayer ceramic capacitor 100 according to a first embodiment includes a multilayer chip 30 in which dielectric layers 10 made of a dielectric ceramic and internal electrodes 20 made of metal as a main component are alternately laminated in the T direction. The multilayer chip 30 includes cover layers 50 formed of a dielectric ceramic at both ends in the lamination direction (T direction). The multilayer chip 30 has a pair of lead-out surfaces 40a and 40b that face each other in the length direction (L direction) and to which the internal electrodes 20 are led out alternately. That is, the multilayer chip 30 includes the lead-out surface 40a where internal electrodes 20a are led out in the L direction, and the lead-out surface 40b where internal electrodes 20b are led out in the L direction. The multilayer chip 30 may have side margins 60 formed on a pair of side surfaces facing each other in the W direction, that is, on the lead-out surfaces 40a and 40b and side surfaces orthogonal to the cover layers 50. The multilayer ceramic capacitor 100 according to the first embodiment includes a connection conductor 71a that electrically connects the internal electrodes led out on the lead-out surface 40a of the multilayer chip 30 to each other, a connection conductor 71b that electrically connects the internal electrodes led out on the lead-out surface 40b of the multilayer chip 30 to each other, and a pair of terminal electrodes 72a and 72b that are formed on the surface of one of the cover layers 50 at an interval from each other and are electrically connected to the connection conductors 71a and 71b, respectively. In the multilayer ceramic capacitor 100 according to the first embodiment, the connection conductor 71a and the terminal electrode 72a are integrally formed, and the connection conductor 71b and the terminal electrode 72b are integrally formed to define external electrodes 70a and 70b, respectively.

Hereinafter, each portion constituting the multilayer ceramic capacitor 100 according to the first embodiment will be described in detail.

### (Dielectric Layer)

A dielectric layer 10 is formed of a dielectric ceramic. The composition of the dielectric ceramic is not particularly limited, and may be appropriately selected according to the characteristics required for the multilayer ceramic capacitor. A preferable composition of the dielectric ceramic is, for example, a composition containing barium titanate (BaTiO₃) as a main component. The dielectric layer 10 may contain the following additive elements. Examples of the additive element include at least one selected from Mo, Nb, Ta, W, Mg, Mn, V, Cr, and rare earth elements (Y, Sm, Eu, Gd, Tb, Dy, Ho, Er, Tm, and Yb), and Co, Ni, Li, B, Na, K, and Si. The additive element may be contained as a simple substance of the element, or may be contained in the form of a compound such as an oxide, a nitride, or a carbide. The additive element may be present in a state of being dissolved in barium titanate as the main component, or may form a hetero-phase with an element constituting the main component or another additive element.

### (Internal Electrode)

An internal electrode 20 is mainly composed of metal. The type of metal is not particularly limited, but a metal containing nickel (Ni) as a main component element is preferable because it can be fired simultaneously with the dielectric layer 10 and is inexpensive. Here, the “main component element” in the present specification means an element having the largest content expressed in atomic percentage (atom %).

The internal electrode 20 may contain, in addition to the metal, a dielectric powder having the same composition as the dielectric ceramic constituting the dielectric layer 10, or a glass component.

### (Cover Layer)

The cover layer 50 functions as a protection portion that protects the dielectric layer 10 and the internal electrode 20.

The material of the main phase of the cover layer 50 is not limited as long as the cover layer 50 has high electrical insulation and low permeability to deterioration factors such as moisture. From the viewpoint of making shrinkage during firing uniform when manufacturing the multilayer ceramic capacitor 100, relaxing internal stress in the multilayer ceramic capacitor 100, and the like, the main phase of the cover layer 50 is preferably the same as the dielectric ceramic forming the dielectric layer 10.

At least one of the cover layers 50 has the terminal electrode 72a and 72b described later on its surfaces, and the cover layer 50 having the terminal electrode 72a and 72b on its surfaces has terminal electrode facing portions 51a and 51b that overlap the terminal electrodes 72a and 72b when viewed from the lamination direction, and a terminal electrode non-facing portion 52 that does not overlap the terminal electrodes 72a and 72b when viewed from the lamination direction.

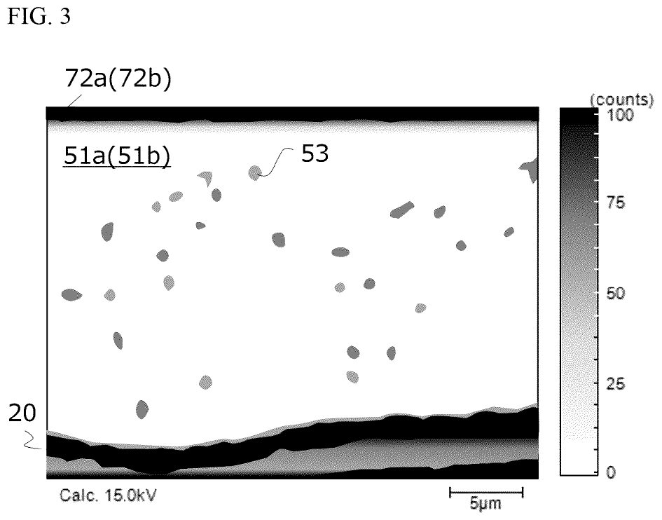

As illustrated in FIG. 3, the terminal electrode facing portion 51a and the terminal electrode facing portion 51b each have a nickel segregation region 53 having a maximum size of 0.4 μm or more and having a higher nickel concentration than the surroundings in element distribution maps Ma and Mb generated by measuring a concentration distribution of nickel in any cross section parallel to the lamination direction, and the density of the nickel segregation region 53 having a maximum size of 0.5 μm or more in the nickel segregation regions is 0.015 or more per 1 μm². This can suppress the occurrence of cracks in the cover layers 50 due to external force when the multilayer ceramic capacitor is mounted on a circuit substrate. This is presumably because the multilayer ceramic capacitor 100 has a structure in which a large number of nickel segregation regions 53 having a high Young's modules are present in a relatively large size in the terminal electrode facing portions 51a and 51b where stresses are likely to concentrate, and thus the stresses are absorbed and relaxed. The density of the nickel segregation region 53 having a maximum size of 0.5 μm or more in the terminal electrode facing portions 51a and 51b are preferably 0.020 or more per 1 μm², and more preferably 0.025 or more per 1 μm², from the viewpoint of significantly suppressing the cracks in the cover layers 50.

The terminal electrode facing portion 51a and 51b preferably have the nickel segregation region 53 having a maximum size of 0.7 μm or more in the element distribution maps Ma and Mb. This increases the stress relaxation effect described above, and can more effectively suppress the occurrence of cracks in the cover layers 50 due to external force.

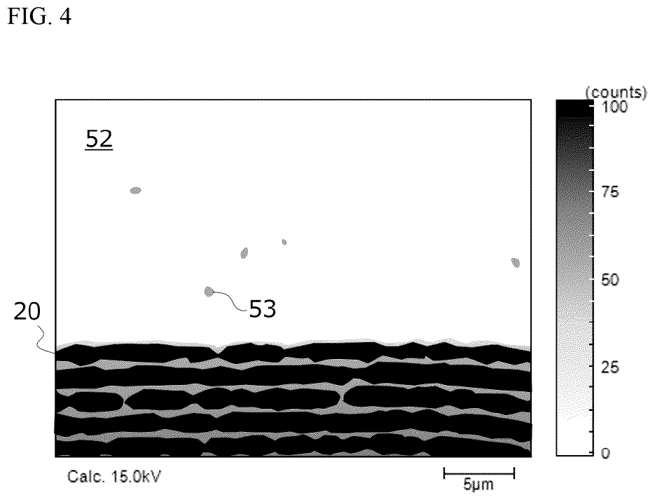

In the terminal electrode non-facing portion 52, as illustrated in FIG. 4, in the element distribution map Mm generated by measuring the concentration distribution of nickel in any cross section parallel to the lamination direction, the density of the nickel segregation regions 53 having a maximum dimension of 0.5 μm or more is 0.008 or less per 1 μm². As described above, since a large number of nickel segregation regions 53 having high conductivity are not present in a large dimension between the terminal electrodes 72a and 72b, electrical insulation between the terminal electrodes 72a and 72b are secured, and short-circuiting between the terminal electrodes 72a and 72b can be suppressed. The density of the nickel segregation regions 53 having a maximum dimension of 0.5 μm or more in the terminal electrode non-facing portion 52 is preferably 0.005 or less per 1 μm², and more preferably 0.003 or less per 1 μm², from the viewpoint of obtaining more excellent electrical insulation. In the terminal electrode non-facing portion 52, it is more preferable that the nickel segregation region 53 having a maximum dimension of 0.5 μm or more does not exist in the element distribution map generated by measuring the concentration distribution of nickel in any cross section parallel to the lamination direction.

Here, the element distribution maps Ma, Mb, and Mm of the cross sections of the terminal electrode facing portions 51a and 51b and the terminal electrode non-facing portion 52 parallel to the lamination direction are generated in the following procedure. First, the vicinity of the central portion in the W direction of the multilayer ceramic capacitor is cut along a plane that passes through the terminal electrodes 72a and 72b and is parallel or substantially parallel to the lamination direction. Next, the cut multilayer ceramic capacitor is embedded in a resin so that the cut surface is exposed, and the resin is cured. Next, the cut surface exposed from the cured resin is mirror-polished. Next, carbon is vapor-deposited on the polished cut surface to impart conductivity, thereby obtaining a measurement sample. Next, the concentration distribution of nickel is measured by a field emission electron probe microanalyzer (FE-EPMA) for each of the terminal electrode facing portions 51a and 51b and the terminal electrode non-facing portion 52 in the cover layer 50 of the measuring sample. The measuring conditions are as follows: acceleration voltage is 15 kV, irradiating current is 50 nA, and measuring time per measuring point is 50 milliseconds. Next, an element distribution map is displayed based on the obtained measurement result. The element distribution map is displayed by calculating a relative value of Ni-Kα ray intensity at each measurement point when the maximum intensity of the Ni-Kα ray obtained in the measurement region is set to 100, and by color-coding the relative value for each intensity.

In addition, in the element distribution maps Ma, Mb, and Mm, the determination of the nickel segregation region 53, the measurement of the maximum dimension thereof, and the calculation of the density of the nickel segregation regions 53 having a maximum dimension of 0.5 μm or more are performed in the following procedure. First, in the element distribution map to be analyzed, a region in which the relative intensity of the Ni-Kα ray is 25 or more and which is separated by a region in which the relative intensity of the Ni-Kα ray is less than 25 is set as a candidate for one nickel segregation region 53. Next, for each of the candidates for the nickel segregation region 53, a line segment having a maximum length among line segments connecting any two points on the outer periphery is determined, and the candidate including a line segment having a maximum dimension, which is the length of 0.4 μm or more, is determined as the nickel segregation region 53. Then, the maximum dimension obtained for each nickel segregation region 53 is defined as the maximum dimension of each nickel segregation region 53. Next, the number of nickel segregation regions 53 having a maximum dimension of 0.5 μm or more, which are confirmed in the element distribution map, is divided by an area (μm²) of the element distribution map to calculate the density of the nickel segregation regions 53. When the terminal electrode 72a (72b) and the internal electrodes 20 are confirmed in the element distribution map Ma (Mb) as illustrated in FIG. 3, and when the internal electrodes 20 are confirmed in the element distribution map Mm as illustrated in FIG. 4, an area of a portion corresponding to the cover layer 50 is measured and calculated, and the number of the nickel segregation regions 53 is divided by the obtained value (μm²) of the area to calculate the density of the nickel segregation regions 53.

The terminal electrode facing portions 51a and 51b preferably have nickel diffusion regions in which the concentration of nickel decreases with increasing distances from the respective terminals in the vicinity of the interfaces with the terminal electrodes 72a and 72b, respectively. The fact that the terminal electrode facing portion 51a and 51b have the nickel diffusion regions suggests that the nickel segregation regions 53 are formed by the diffusion of nickel from the terminal electrodes 72a and 72b. The nickel segregation region 53 formed in this manner forms a better interface with the surrounding ceramic particles than a nickel segregation region formed by containing nickel or nickel oxide particles in the green sheet for forming the cover layer, and therefore, exhibits an excellent suppression effect of the cracks.

### (Side Margin)

The side margin 60 functions as a protection portion that protects the dielectric layer 10 and the internal electrode 20.

The material of the side margin 60 is not limited as long as the material has high electrical insulation and low permeability to deterioration factors such as moisture. From the viewpoint of making the shrinkage during firing uniform when manufacturing the multilayer ceramic capacitor 100, relaxing the internal stress in the multilayer ceramic capacitor 100, and the like, the material of the cover layer 50 and the side margin 60 is preferably the same as the dielectric ceramic forming the dielectric layer 10.

### (Connection Conductor)

The connection conductor 71a electrically connects the internal electrodes 20a led out on the lead-out surface 40a of the multilayer chip 30 to each other, and the connection conductor 71b electrically connects the internal electrodes 20b led out on the lead-out surface 40b of the multilayer chip 30 to each other. As illustrated in FIGS. 1 and 2, the connection conductors 71a and 71b may be formed to extend to the surfaces of the cover layers 50 and the side margins 60 on which the terminal electrodes 72a and 72b are not formed.

Materials of the connection conductors 71a and 71b are not particularly limited as long as the materials have conductivity. Examples of the materials include metals such as nickel (Ni), copper (Cu), tin (Sn), palladium (Pd), platinum (Pt), silver (Ag), and gold (Au), alloys containing any of these metals as a main component element, and conductive resins. However, when the connection conductors 71a and 71b are formed by co-firing with the multilayer chip 30, Ni, Pd, Pt, and the like are preferably used because thermal stability and chemical stability that do not cause melting or oxidation during firing are required in addition to conductivity.

### (Terminal Electrode)

The terminal electrodes 72a and 72b are formed on one of the cover layers 50 with a space therebetween, and are electrically connected to the connection conductors 71a and 71b, respectively.

At least a portion of each of the terminal electrodes 72a and 72b that is in contact with the cover layer 50 contains a metal containing nickel as a main component. This is necessary for forming the nickel segregation region 53 in the terminal electrode facing portions 51a and 51b of the cover layer 50 by firing the multilayer chip 30 and at least a portion of the terminal electrodes 72a and 72b at the same time when manufacturing the multilayer ceramic capacitor, as described later. Examples of the metal containing nickel as a main component element include nickel and a nickel alloy. In FIG. 1, a region containing a metal containing nickel as a main component element is denoted as a region 73.

The thickness of the region 73 containing a metal containing nickel as a main component element is preferably 0.1 μm or more and 1.5 μm or less. The metal layer having such a thickness can be suitably formed by a physical vapor deposition (PVD) method or a thermal spraying method. As described later, the portions of the terminal electrodes 72a and 72b that are in contact with the cover layer 50 are formed by the physical vapor deposition (PVD) method or the thermal spraying method, and then fired, so that the nickel segregation regions 53 can be effectively formed in the terminal electrode facing portions 51a and 51b of the cover layer 50. The thickness of the region 73 containing a metal containing nickel as a main component element is more preferably 0.2 μm or more and 1.0 μm or less.

The determination that the portion where the terminal electrodes 72a and 72b are in contact with the cover layer 50 contains a metal containing nickel as a main component element and the measurement of the thickness of the region 73 containing a metal containing nickel as a main component element are performed in the following procedure. First, the vicinity of the central portion in the W direction of the multilayer ceramic capacitor is cut along a plane that passes through the terminal electrodes 72a and 72b and is parallel or substantially parallel to the lamination direction. Next, the cut multilayer ceramic capacitor is embedded in a resin so that the cut surface is exposed, and the resin is cured. Next, the cut surface exposed from the cured resin is mirror-polished to obtain a measurement sample. Next, the measurement sample is observed with a scanning electron microscopy (SEM) equipped with an energy-dispersive X-ray spectroscopy (EDS) detector or a wavelength-dispersive X-ray spectroscopy (WDS) detector to identify the positions of the terminal electrodes 72a and 72b, and then the terminal electrodes 72a and 72b are subjected to line analysis in the thickness direction by the EDS measurement or WDS measurement. Next, the concentration of the element detected at each measurement point is calculated in atomic percent (atom %) from the obtained analysis results. Then, when the atomic percentage of nickel among the detected elements is the highest at a measurement point closest to the cover layer 50, it is determined that the portion in contact with the cover layer 50 contains a metal containing nickel as a main component element. In addition, for the terminal electrode for which the above determination has been made, the distance between a measurement point closest to the cover layer 50 and a measurement point immediately before a measurement point at which the atomic percentage of the element other than nickel is the highest, counting from the measurement point closest to the cover layer 50, is measured, and the obtained value is taken as the thickness of the region 73 containing a metal containing nickel as a main component element.

The terminal electrodes 72a and 72b may be made of other materials having conductivity, except for the portion in contact with the cover layer 50. Examples of the material include, in addition to Ni, metals such as copper (Cu), tin (Sn), palladium (Pd), platinum (Pt), silver (Ag), and gold (Au), alloys containing any of these metals as a main component element, and conductive resins. In the multilayer ceramic capacitor 100 according to the first preferred embodiment illustrated in FIG. 1, the entire outer electrodes 70a and 70b formed by the terminal electrodes 72a and 72b and the connection conductors 71a and 71b have a multilayer structure in which a Cu layer 74, a Ni layer 75, and a Sn layer 76 are formed in the order from closest to farthest from the surface of metal layer and on the surface of metal layer including nickel as a main component element.

### Second Embodiment

An embodiment of a multilayer ceramic capacitor according to a second aspect of the present disclosure will be described below as a second embodiment.

The multilayer ceramic capacitor according to the second embodiment has a basic structure common to the multilayer ceramic capacitor according to the first embodiment illustrated in FIGS. 1 and 2, and is different only in the distribution of the nickel segregation regions 53 in the cover layer 50. The characteristic portions will be described using the reference numerals illustrated in FIGS. 1 and 2. The multilayer ceramic capacitor according to the second embodiment is the same as that according to the first embodiment except for the distribution of the nickel segregation regions 53 in the cover layer 50, and thus the description thereof will be omitted.

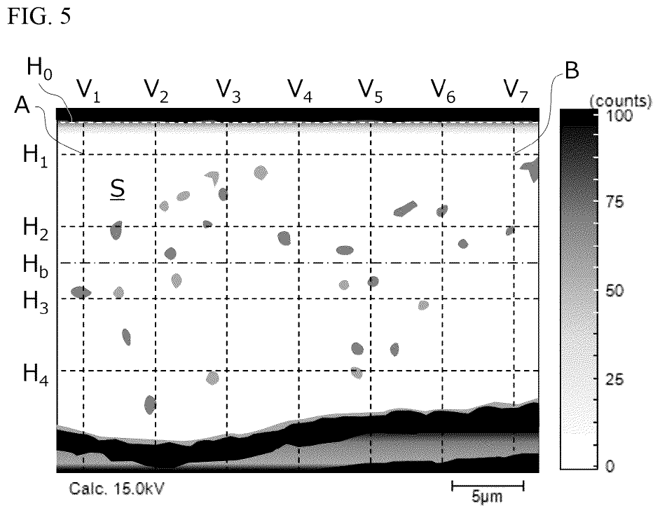

In the cover layer 50 of the ceramic capacitor according to the second embodiment, as illustrated in FIG. 5, when each of element distribution maps Ma and Mb generated by measuring the concentration distribution of nickel in any cross section parallel to the lamination direction in the terminal electrode facing portions 51a and 51b are divided by square cells S each having a side of 5 μm, the number of cells in which the nickel segregation region 53 having a maximum size of 0.4 μm or more and having a higher nickel concentration than the surroundings is included is 50% or more of the total number of cells. This means that the nickel segregation regions 53 are distributed over a wide range of the terminal electrode facing portions 51a and 51b. Such a wide distribution of the nickel segregation regions 53 can suppress the occurrence of cracks in the cover layer 50 due to external force when the multilayer ceramic capacitor 100 is mounted on the circuit substrate. This is presumably because the nickel segregation regions 53 having high Young's modules are evenly present in the terminal electrode facing portions 51a and 51b where stresses are likely to concentrate due to the structure of the multilayer ceramic capacitor, and thus the absorption and relaxation effect of stress are exhibited over the entire region. The percentage of the number of cells in which the nickel segregation region 53 is included is preferably 60% or more, and more preferably 70% or more, in that the effect of suppressing cracks in the cover layer 50 becomes remarkable.

For the same reason as in the first embodiment, the terminal electrode facing portions 51a and 51b preferably have the nickel segregation regions 53 having a maximum size of 0.7 μm or more in the element distribution maps Ma and Mb. In order to increase the stress relaxation effect and more effectively suppress the occurrence of cracks in the cover layer 50 due to external force, it is more preferable that in the terminal-electrode facing portions 51a and 51b, the nickel segregation regions 53 having a maximum size of 0.7 μm or more are included in 10% or more of the square cells S in the element distribution maps Ma and Mb. The percentage of the square cells S in which the nickel segregation region 53 having a maximum dimension of 0.7 μm or more is included is more preferably 15% or more, and particularly preferably 20% or more.

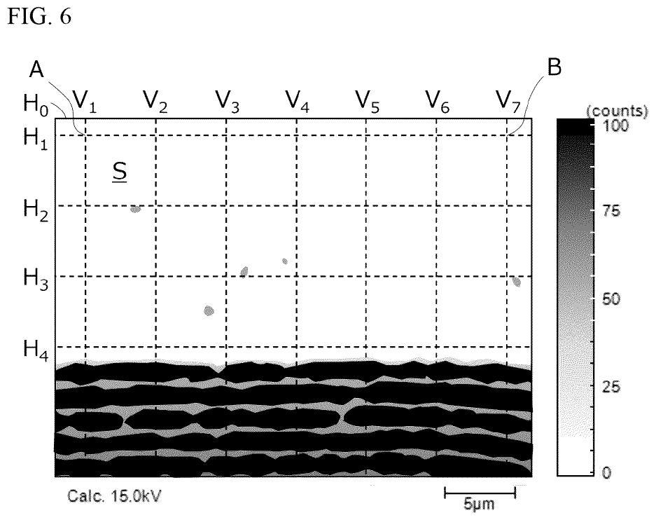

As illustrated in FIG. 6, in the cover layer 50 of the multilayer ceramic capacitor according to the second embodiment, when an element distribution map Mm generated by measuring the concentration distribution of nickel in any cross section parallel to the lamination direction in the terminal electrode non-facing portion 52 is divided into square cells each having a side of about 5 μm, the number of cells in which the nickel segregation region is included is about 5% or less of the total number of cells. Even when the nickel segregation region 53 having high conductivity is present between the terminal electrodes 72a and 72b, the electrical insulation between the terminal electrodes 72a and 72b is ensured and short-circuiting can be suppressed as long as the nickel segregation region 53 is concentrated at a specific position or the nickel segregation regions 53 are sufficiently spaced from each other. The percentage of the number of cells in which the nickel segregation region 53 is included in the terminal electrode non-facing portion 52 is preferably 3% or less, and more preferably 1% or less, from the viewpoint of obtaining more excellent electrical insulation.

Here, the element distribution maps Ma, Mb, and Mm in the multilayer ceramic capacitor according to the second embodiment are generated by the same procedure as the element distribution maps Ma, Mb, and Mm in the ceramic capacitor according to the first embodiment described above. In addition, the determination of the nickel segregation region 53 and the measurement of the maximum dimension of the nickel segregation region 53 in the element distribution map are also performed by the same procedure as the determination of the nickel segregation region 53 and the measurement of the maximum dimension of the nickel segregation region 53 in the multilayer ceramic capacitor according to the first embodiment described above.

The element distribution maps Ma, Mb, and Mm are divided by square cells S each having a side of 5 μm as follows. In the element distribution maps Ma and Mb, as illustrated in FIG. 5, a shortest distances between regions having an extremely high nickel concentration (the relative intensity of Ni-Kα radiation is 95 or more), which are located with the terminal electrode facing portion 51a (51b) interposed therebetween, is measured. Since the region having an extremely high nickel concentration corresponds to each of the terminal electrode 72a (72b) and the internal electrode 20, these element names are used in the following description when both are distinguished from each other. Next, a line segment passing through the points located on the terminal electrode 72a (72b) among the points at which the shortest distances are obtained and parallel to the upper and lower sides of the element distribution map Ma (Mb) is drawn as a baseline H₀. Next, a remainder r1 obtained by dividing the shortest distance by a length corresponding to 5 μm in the element distribution map Ma (Mb) is divided by 2, and a line segment H₁ parallel to the base line is drawn at a position separated from the base line H₀ toward the internal electrode by a value r₁/2 obtained. The length of the line segment H₁ is a length in which both ends of the line segment H₁ reach the ends of the element distribution map Ma (Mb). Then, line segments H₂, H₃, . . . , Hₘ parallel to the line segment H₁ are drawn from the line segment H₁ to the vicinity of the internal electrode 20 at intervals corresponding to 5 μm in the element distribution map Ma (Mb). In FIG. 5, m=4. It is assumed that both ends of these line segments reach the ends of the element distribution map Ma (Mb), similarly to the line segment H₁. Next, the length of the line segment H₁ is measured, and the remainder r₂ obtained by dividing the length by a length corresponding to 5 μm in the element distribution map Ma (Mb) is divided by 2 to calculate r₂/2. Next, a line segment orthogonal to the line segment H₁ is drawn from a point A on the line segment H₁, which is at a distance of r₂/2 from one end of the line segment H₁, toward the internal electrode 20, and this line segment is defined as a line segment V₁. Next, line segments V₂, V₃, . . . , Vₙ parallel to the line segment V₁ are drawn from the line segment V₁ toward a facing point (point B in FIG. 5) on the line segment H₁ at intervals corresponding to 5 μm in the element distribution map Ma (Mb). In FIG. 5, n=7. Then, an individual region divided by the drawn line segments H₁, H₂, . . . , Hₘ and V₁, V₂, . . . , Vₙ is defined as one square cell S. The element distribution map Mm may be drawn in the same manner as described above, by replacing the terminal electrode 72a (72b) with the surface of the cover layer 50.

In each of the terminal electrode facing portions 51a and 51b, when the square cells S obtained by dividing the element distribution maps Ma and Mb are divided into surface layer cells Sₛ located closer to the terminal electrode 72a (72b) than the central portion in the thickness direction of the cover layer 50 and internal cells Sᵢ located closer to the internal electrode 20 than the central portion in the thickness direction of the cover layer, the percentage of the number of cells in which the nickel segregation region is included is preferably higher in the surface layer cells Sₛ than in the internal cells Sᵢ. This enhances the stress relaxation effect in the vicinity of the surface where stress is more likely to concentrate and cracks are likely to occur, and the effect of suppressing cracks becomes significant.

Here, in the element distribution maps Ma and Mb in which the square cells are drawn, when a line segment H_{b} is drawn at an equal distance from the baseline H₀ and a line segment Hₘ parallel thereto and closest to the internal electrode 20, the surface layer cell Sₛ is a cell located closer to the terminal electrode 72a (72b) than the line segment H_{b}. On the other hand, the internal cell Sᵢ is a cell located closer to the internal electrode 20 than the line segment H_{b}. Therefore, when the number of cells S arranged in the thickness direction of the cover layer 50 is an even number, all the cells S are classified as either the surface cells Sₛ or the internal cells Sᵢ, and when the number of cells S arranged in the thickness direction of the cover layer 50 is an odd number, the cells S located in the central portion in the thickness direction are not classified as either the surface cells Sₛ or the internal cells Sᵢ.

### First Modification

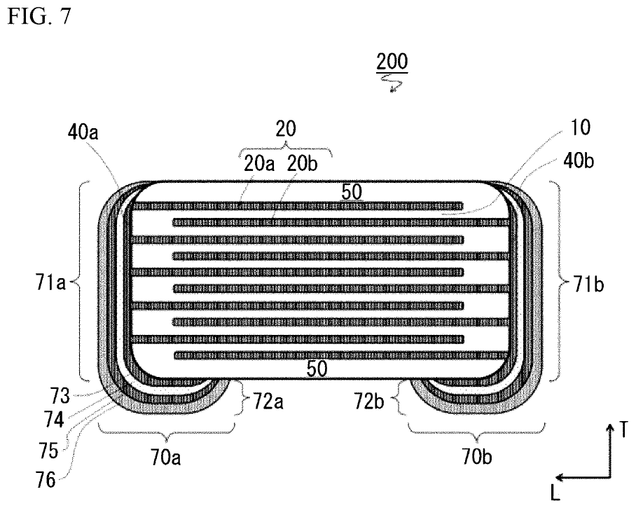

As a first modification of the multilayer ceramic capacitor according to the first and second aspects, a multilayer ceramic capacitor 200 in which the external electrodes 70a and 70b are disposed on the surfaces of the multilayer chip 30 in an L-shape in cross-sectional view as illustrated in FIG. 7 is exemplified. The multilayer ceramic capacitor 200 having such a structure has an advantage that the height can be reduced because the connection conductors 71a and 71b do not extend around to the upper cover layer.

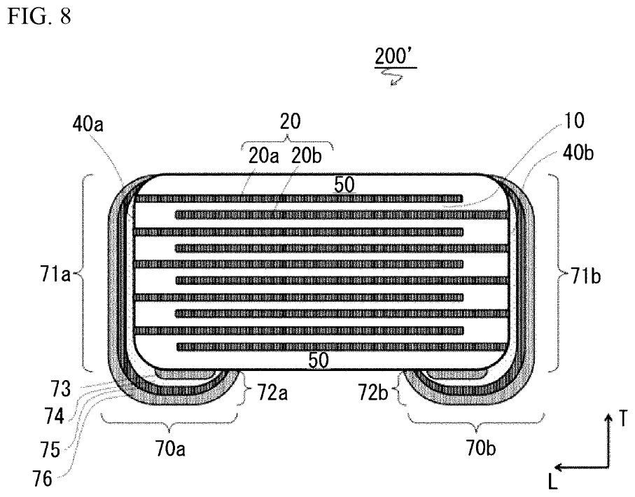

In addition, the first modification may be a multilayer ceramic capacitor 200′ in which the region 73 containing a metal containing nickel as a main component element is not present in the portions of the connection conductors 71a and 71b in contact with the multilayer chip 30, and the connection conductors 71a and 71b are formed by plating, as illustrated in FIG. 8. The multilayer ceramic capacitor 200′ having such a structure can reduce the total thickness of the connection conductors 71a and 71b, and thus has an advantage that the size in the L direction can be reduced in addition to the reduction in height.

### Second Modification

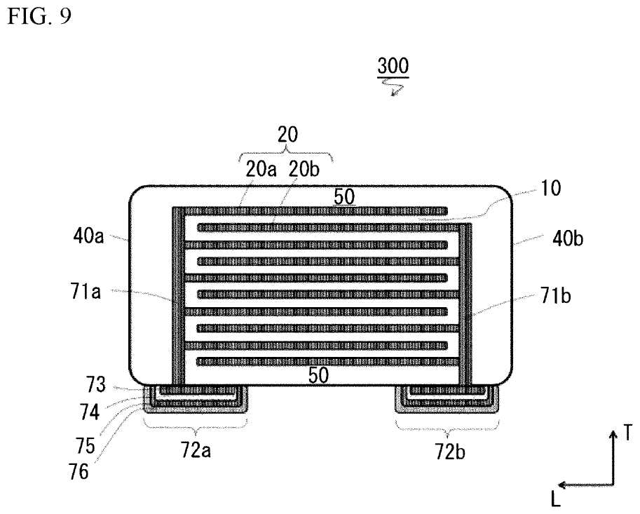

As a second modification of the multilayer ceramic capacitor according to the first and second aspects, a multilayer ceramic capacitor 300 in which the connection conductors 71a and 71b are formed inside the multilayer chip 30 and are led out to one of the cover layers is provided as illustrated in FIG. 9. The multilayer ceramic capacitor 300 having such a structure has an advantage that the size of the multilayer ceramic capacitor 300 can be reduced because the connection conductors 71a and 71b are not present on the surfaces of the multilayer chip 30.

### Third Modification

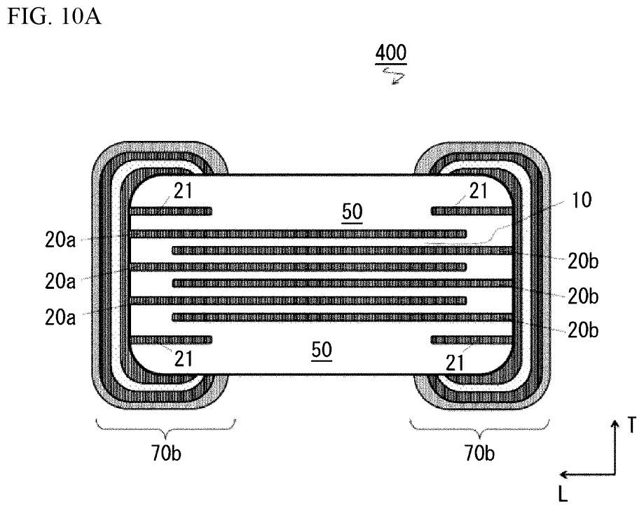

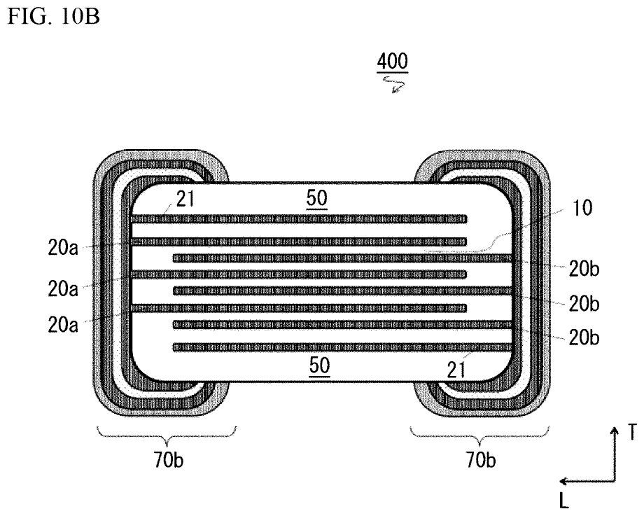

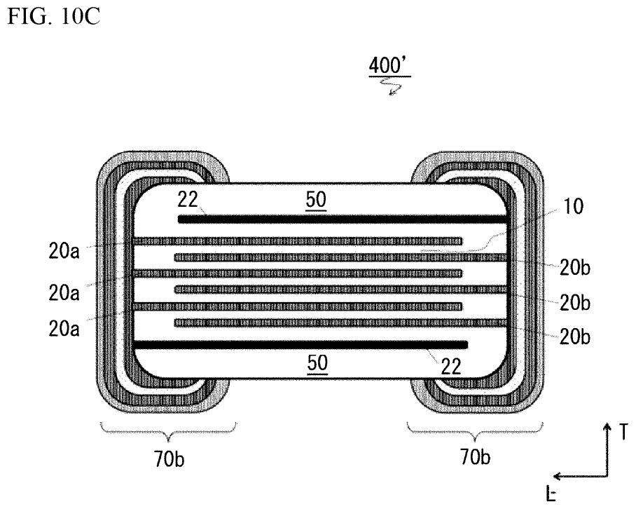

As a third modification of the multilayer ceramic capacitor according to the first and second aspects, a multilayer ceramic capacitor 400 in which additional electrodes 21 that do not contribute to capacitance formation are disposed in the cover layers 50 as illustrated in FIGS. 10A and 10B, and a multilayer ceramic capacitor 400′ in which metal-oxide layers 22 included in the internal electrodes 20 are disposed in the cover layers 50 as illustrated in FIG. 10C are exemplified. In the multilayer ceramic capacitors 400 and 400′ having such a structure, when the terminal electrode 72a and 72b and the connection conductor 71a and 71b formed to extend to the surfaces of the cover layers are co-fired with the multilayer chip 30, the additional electrodes 21 and the metal-oxide layers 22 each function as a barrier against nickel diffusion, and leakage current between the external electrodes 70a and 70b and the internal electrodes 20, which may be caused by the cover layers 50 containing nickel in the entire thickness direction, can be suppressed.

### Fourth Modification

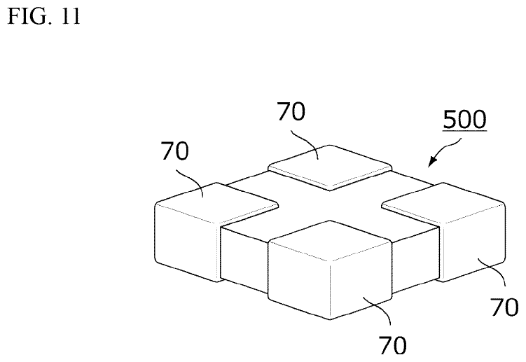

As a fourth modification of the multilayer ceramic capacitor according to the first and second aspects, a multilayer ceramic capacitor 500 in which the external electrodes 70 are disposed at four locations is exemplified as illustrated in FIG. 11. The multilayer ceramic capacitor having such a structure also achieves the advantageous effects of embodiments of the present disclosure that the occurrence of cracks in the cover layers due to the concentration of external stress can be suppressed and that short-circuiting between the terminal electrodes can be suppressed.

### [Method of Manufacturing Multilayer Ceramic Capacitor]

### Third Embodiment

An embodiment of a method for manufacturing a multilayer ceramic capacitor according to a third aspect of the present disclosure will be described below as a third embodiment.

A method of manufacturing a multilayer ceramic capacitor according to the third embodiment is to manufacture a multilayer ceramic capacitor according to the first embodiment or the second embodiment described above, and includes preparing a powder of a dielectric ceramic composition, mixing the powder of the dielectric ceramic composition with a binder, and molding the mixture into a sheet shape to obtain a green sheet, forming an internal electrode pattern including a metal on the green sheet, laminating a predetermined number of green sheets on which the internal pattern is formed, disposing green sheets for cover layers at both ends in a lamination direction, and then pressure-bonding the green sheets to obtain an unfired laminated body, cutting the unfired laminated body to obtain an unfired laminated chip having lead-out surfaces, removing the binder from the unfired laminated chip, forming a plurality of metal layers containing nickel as a main component element on a surface of at least one of the green sheets for cover layers in the unfired laminated chip after removal of the binder by a physical vapor deposition method or a thermal spraying method, the plurality of metal layers being spaced from each other, and firing an unfired molded body on which the plurality of metal layers are formed to obtain a sintered body. Hereinafter, each operation in the case of manufacturing the multilayer ceramic capacitor having the structure illustrated in FIGS. 1 and 2 or FIG. 7 will be described in detail.

### (Preparation of Powder of Dielectric Ceramic Composition)

The powders of the dielectric ceramic composition are obtained by mixing various raw material powders containing the constituent elements thereof at a predetermined ratio and pre-firing (temporarily firing) the mixture. When mixing the various raw material powders at the predetermined ratio, various additives such as the above-described additive elements and sintering aids may be further added, and these various additives may be further added to the powders after the pre-firing.

The method of mixing the raw material powders is not particularly limited as long as the powders are uniformly mixed while suppressing the mixing of impurities, and either dry mixing or wet mixing may be employed. In the case of employing wet mixing using a ball mill as a mixing method, for example, partially stabilized zirconia (PSZ) ball is used, and the mixture is stirred for about 8 hours to 60 hours by a ball mill using an organic solvent such as ethanol or water as a dispersion medium, and then the dispersion medium is volatilized and dried.

The pre-firing conditions of the raw material mixed powders are not particularly limited as long as the above-described various raw material powders react to obtain a predetermined dielectric ceramic composition. As an example, the firing is performed in the air at a temperature of 800° C. to 1100° C. for 1 hour to 10 hours. The powders after the pre-firing may be processed into a green sheet as it is, but it is preferable to crush the powder by a ball mill, a stamp mill, or the like, from the viewpoint of obtaining a smooth green sheet through a uniform slurry and increasing sinterability.

When commercially available dielectric ceramic composition powders can be used, the following operations may be performed on the powders without performing the mixing and the pre-firing of the raw material powders described above.

### (Preparation of Green Sheet)

The green sheet is obtained by mixing the powders of the dielectric ceramic composition described above with a binder and a dispersion medium to prepare a slurry, and molding the slurry into a sheet shape.

A binder which can maintain the shape of the green sheet and is volatilized without leaving carbon or the like by a binder removal treatment prior to the firing is used. Examples of binders that can be used include binders based on polyvinyl alcohol, polyvinyl butyral, cellulose, urethane, and vinyl acetate. The amount of the binder used is not particularly limited, but is preferably as small as possible within a range in which desired formability and shape retention are obtained, from the viewpoint of reducing the raw material cost, because the binder is removed in a subsequent step.

As the dispersion medium, a medium that does not cause aggregation of the calcined powder and the binder and can be easily removed by volatilization or the like after the green sheet formation described later is used. Examples of the dispersion medium that can be used include water and alcohol-based solvents.

Components for adjusting the properties of the slurry, such as a dispersant, a plasticizer, and a thickener, may be added to the slurry.

A method for mixing the mixed powder with the binder and the dispersion medium is not particularly limited as long as the components are uniformly mixed while preventing the mixing of impurities. One example is ball mill mixing.

As a method of forming the prepared slurry into the sheet shape to obtain the green sheet, a commonly used method such as a doctor blade method can be adopted.

### (Formation of Internal Electrode Pattern)

The formation of the internal electrode pattern containing a metal on the green sheet described above can be performed by a method of printing or applying an internal electrode paste on the green sheet in a predetermined pattern, or a method of forming a metal film on the green sheet in a predetermined pattern by vapor deposition or sputtering.

When the internal electrode pattern is formed using the internal electrode paste, the internal electrode paste to be used is obtained by mixing particles of a metal forming the internal electrode and a vehicle with a three roll mill. The internal electrode paste may contain glass frit or dielectric ceramic composition powders in addition to the above-described components.

The types and amounts of the binder and the solvent contained in the vehicle to be used are not limited, and may be appropriately selected in consideration of the viscosity of the internal electrode paste, the ease of handling, the compatibility with the green sheet, and the like.

The printing of the internal electrode paste on the green sheet can be performed using, for example, a screen mask on which a predetermined internal electrode pattern is formed. The printing may be performed with a space to be the side margin when the multilayer ceramic capacitor is formed.

### (Production of Unfired Laminated Body)

The unfired laminated body is obtained by laminating a predetermined number of green sheets on which the internal electrode pattern is formed and pressure-bonding the green sheets to each other. The lamination and the pressure bonding may be performed by a commonly used method, and a method of pressing the laminated green sheets in the lamination direction while heating the sheets and performing thermocompression bonding by the action of the binder, or the like can be employed.

In the lamination and the pressure bonding, green sheets that are cover layers when the multilayer ceramic capacitor is formed are added to both ends of the unfired laminated body in the lamination direction. In this case, the additional green sheets may have the same composition as the green sheet on which the internal electrode pattern is printed, or may have a different composition from the green sheets on which the internal electrode pattern is printed. From the viewpoint of making the shrinkage rates at the time of firing uniform, the composition of the additional green sheets is preferably the same as or similar to the composition of the green sheets on which the internal electrode pattern is printed.

### (Production of Unfired Laminated Chip)

The unfired laminated chip is obtained by dividing the unfired laminated body into individual multilayer chips. By the division, a pair of lead-out surfaces parallel to the lamination direction and facing each other, from which the internal electrode patterns are led out every other layer, are formed. For the division, a commonly used means such as a dicing saw or a laser cutting machine can be employed.

### (Removal of Binder)

The binder is volatilized and removed from the obtained unfired laminated chip by heating. The heating conditions may be appropriately set in consideration of the volatilization temperature of the binder and the content of the binder. As an example, the temperature is maintained at 200° C. to 500° C. for 5 hours to 20 hours in a nitrogen (N2) atmosphere.

### (Formation of Metal Layer)

The formation of the metal layer containing nickel as a main component element on the surface of the green sheet for the cover layer in the unfired laminated chip from which the binder has been removed is performed by a physical vapor deposition (PVD) method or a thermal spraying method. This facilitates the formation of the nickel segregation regions in the cover layer. Although the reason for this is not clear, it is considered that the metal layer formed by the physical vapor deposition method or the thermal spraying method is constituted by extremely fine metal particles at the atomic level, and the surface energy of each metal particle is high, and therefore, when the metal is diffused into the cover layer during firing described later, the metal particles are likely to form clusters inside the cover layer, which has an influence. Examples of the PVD method that can be used include a vapor deposition method, a sputtering method, and an ion plating method. Examples of the thermal spraying method that can be used include a flame spraying method, an arc spraying method, and a plasma spraying method.

The shape of the metal layer to be formed may be any shape as long as it corresponds to the shape of each of the terminal electrodes on the surface of one of green sheets for cover layer, that is, the shape of each of the plurality of metal layers spaced from each other. The metal layer may be formed only on the surface of one of the green sheets for cover layer, the metal layer may be formed also on the lead-out surfaces of the unfired laminated chip in addition to the above, and the metal layer may be formed up to the surface of the other of the green sheets for cover layer.

### (Firing of Unfired Laminated Chip)

The unfired laminated chip is fired by heating the unfired laminated chip on which the metal layer is formed at a predetermined temperature. The firing conditions are set in consideration of the diffusion state of nickel into the cover layer, because nickel contained in the metal layer is diffused into the cover layer to form the nickel segregation region during firing. In setting the firing conditions, it is preferable to consider the sinterability of the dielectric ceramic composition, and the heat resistance, oxidation resistance, and the like of the metal contained in the internal electrode paste and the metal layer. An example of the firing conditions is as follows: in a reducing atmosphere of a mixture of nitrogen (N₂), hydrogen (H₂), and water vapor (H₂O), the temperature is kept at about 900° C., which is lower than the normal firing temperature, for about 3 hours, and then the temperature is raised to 1000° C. to 1350° C. and kept for 5 minutes to 2 hours. After the firing, a reoxidation treatment may be performed in which the temperature is held at 600° C. to 1000° C. in a nitrogen (N₂) gas atmosphere or a low-oxygen atmosphere. By the firing, the powders of the dielectric ceramic composition are sintered to form the dielectric layer, the internal electrode pattern is sintered to form the internal electrode, and the metal layer is sintered to form the terminal electrode or the connection conductor. At this time, nickel diffuses from the metal layer to the cover layer, and the above-described nickel segregation region and the above-described nickel diffusion region are formed.

The sintered body obtained by the firing may be used as the multilayer ceramic capacitor as it is, or may be used as the multilayer ceramic capacitor after a conductive layer is further formed on the surface of the metal layer formed on the cover layer by means such as plating or vapor deposition. The multilayer ceramic capacitor may be formed by forming the connection conductor that connects the terminal electrode formed on the cover layer and the internal electrodes led out to the lead-out surface. The multilayer ceramic capacitor thus obtained has the structure illustrated in FIGS. 1 and 2, 7, or 8.

A method for manufacturing the multilayer ceramic capacitor according to the third embodiment also contributes to an improvement in the sintered density of the terminal electrode facing portion due to the diffusion of nickel into the cover layer during the firing. The terminal electrode facing portion is a portion to which a pressing pressure is less likely to be applied when the unfired laminated body is produced due to the fact that the number of internal electrodes located in the lamination direction is smaller than that in the terminal electrode non-facing portion, and thus it is difficult to improve a raw density. The cover layer having a low raw density tends to be late in sintering during the firing, and it is difficult to improve a sintered density. However, the terminal electrode facing portion can have a high sintered density due to the above-described diffusion of nickel.

### First Modification of Third Embodiment

In the third embodiment, in order to form connection conductor patterns inside the multilayer chip, through holes may be formed in the green sheets prior to the formation of the internal electrode patterns. As a method of forming the through holes in the green sheets, punching, laser processing, or the like can be employed. By forming the internal electrode patterns on the green sheets having the through holes formed therein, or by filling the through holes with conductors separately from the internal electrode patterns, the green sheets through which the conductors penetrate in the thickness direction are obtained.

When the unfired laminated body is formed by laminating the green sheets through which the conductors penetrate in the thickness direction, the conductors in the through holes are connected to each other in the lamination direction and are connected to the internal electrode patterns formed on the green sheets adjacent to each other in the lamination direction, thereby forming precursors of the connection conductors. At this time, by forming through holes filled with the conductors in one of the green sheets for the cover layer, parts of the precursors of the connection conductors are exposed on the surface of the cover layer.

### Second Modification of Third Embodiment

In the third embodiment, holes from which the internal electrode patterns are led out to the wall surfaces may be formed in the thickness direction (lamination direction) of the unfired laminated body obtained by laminating and pressure-bonding the green sheets, and the holes may be filled with the conductors to form the precursors of the connection conductors.

The multilayer ceramic capacitor obtained by each of the modifications of the third embodiment has the structure illustrated in FIG. 9.

### EXAMPLES

The present disclosure will be described in more detail with reference to the following examples, but the present disclosure is not limited to these examples.

### Example

As the powders of the dielectric ceramic composition, pre-fired barium titanate (BaTiO₃) powders as a main raw material and powders of oxides of Mn, Ho, and Si as trace additive components were prepared. A polyvinyl butyral-based binder and an alcohol-based solvent were added to these powders, and the powders were mixed by a wet ball mill. The obtained mixed slurry was molded by a doctor blade to obtain a green sheet. After nickel paste was screen-printed as a paste for internal electrodes on the green sheet to form an internal electrode pattern, 500 green sheets were laminated, and 20 green sheets for cover layers were laminated on each of the upper and lower surfaces of the laminated green sheets, and then the laminated green sheets were pressed together by applying pressure at about 190 MPa while heating, to obtain the unfired laminated body. The unfired laminated body was cut to obtain an unfired laminated chip having a pair of lead-out surfaces parallel to the lamination direction and facing each other, from which the internal electrode patterns were led out every other layer, and then the unfired laminated chip was heated up to 300° C. in a nitrogen atmosphere to perform a binder removal treatment. An Ni layer serving as a base layer of the external electrode was formed on a part of the cover layer and the lead-out surface of the unfired laminated chip by sputtering. The unfired laminated chip after the Ni layer was formed was held at 900° C. for 3 hours in a so-called reduction-water vapor atmosphere in which water vapor was introduced into a reducing gas containing hydrogen in nitrogen, then heated up to 1200° C., held for 2 hours, fired, and cooled to near room temperature to obtain the sintered body. A Cu layer, a Ni layer, and a Sn layer were formed in the order from closest to farthest by plating on the surface of the Ni layer of the obtained sintered body, and a multilayer ceramic capacitor according to Example 1 was obtained. The obtained multilayer ceramic capacitor had a rectangular shape in which a surface perpendicular to the lamination direction of the multilayer chip was 1.0 mm×0.5 mm, and the thickness of the dielectric layer was 0.6 μm.

### Comparative Example

A multilayer ceramic capacitor according to a comparative example was produced by the same method as the multilayer ceramic capacitor of example 1 except that the method of forming the Ni layer on the unfired laminated chip was dipping in a nickel paste instead of the sputtering method.

### (Occurrence Rate of Crack)

The occurrence rate of cracks in each of the obtained multilayer ceramic capacitor was evaluated by the following procedure. The multilayer ceramic capacitor was mounted on a central portion of a glass epoxy substrate having a length of 100 mm, a width of 40 mm and a thickness of 0.8 mm such that the length direction (L direction) of the multilayer ceramic capacitor coincided with the length direction of the substrate. On the mounting surface of the substrate, a copper foil having a thickness of 0.035 mm is disposed at the central portion in the length direction over the entire width direction. The substrate on which the multilayer ceramic capacitor was mounted was supported at two positions located at distances of 45±2 mm from the central portion in the length direction with the mounting surface facing downward, and the central portion in the length direction was pressed until the downward displacement reached 2 mm, and held for 60 seconds. Thereafter, the appearance of the multilayer ceramic capacitor was observed to confirm the presence or absence of cracks. The above operation was performed on 1000 multilayer ceramic capacitors, and the percentage of the multilayer ceramic capacitors in which cracks were confirmed was defined as the occurrence rate of cracks. The results are illustrated in Table 1.

### [Evaluation of Multilayer Ceramic Capacitor]

### (Generation of Element Distribution Map)

The concentration distribution of nickel was measured by the above-described method for each of the terminal electrode facing portion and the terminal electrode non-facing portion of the cover layer in each multilayer ceramic capacitor subjected to the evaluation of the occurrence rate of cracks, and an element distribution map was generated. In both of the multilayer ceramic capacitors according to the example and the comparative example, it was confirmed that the nickel diffusion region was present in the vicinity of the interface with the terminal electrode in the element distribution map obtained for the terminal electrode facing portion.

### (Nickel Segregation Region)

The element distribution map was generated and analyzed by the above-described method, and the maximum dimension and density of the nickel segregation region and the number of cells in which the nickel segregation region was included were determined. The results are illustrated in Table 1.

TABLE 1

| | | | | Compar- |
|---|---|---|---|---|
| | | | Exam- | ative |
| | | | ple | Example |
| Density of nickel | Terminal electrode | | 0.031 | 0.010 |
| segregation regions | facing portion | | | |
| having maximum | Terminal electrode | | 0.008 | 0.008 |
| dimension of 0.5 μm | non-facing portion | | | |
| or more [piece/μm²] | | | | |
| Presence or absence of nickel segregation regions | | | Pres- | Absence |
| having a maximum dimension of 0.7 μm or more in | | | ence | |
| terminal electrode facing portion | | | | |
| Percentage of square | Terminal | Surface | 90 | 30 |
| cells each having a side | electrode | layer cell | | |
| of 5 μm in which nickel | facing | Internal | 60 | 30 |
| segregation region is | portion | cell | | |
| included [%] | | Whole | 80 | 30 |

| | | |
|---|---|---|
| Terminal electrode | 3 | 3 |
| non-facing portion | | |

| | | |
|---|---|---|
| Percentage of square cells each having a side of | 30 | 0 |
| 5 μm in which nickel segregation region having | | |
| maximum dimension of 0.7 μm or more is included | | |
| in the terminal electrode facing portion [%] | | |
| Occurrence rate of cracks [%] | 0 | 5 |

Table 1 illustrates that, in the element distribution map of the terminal electrode facing portion, the multilayer ceramic capacitors according to the example in which the density of the nickel segregation regions having a maximum dimension of 0.5 μm or more is 0.015 or more per 1 μm² suppress the occurrence of cracks in the cover layer due to concentration of external stress, whereas the multilayer ceramic capacitors according to the comparative example in which the density of the nickel segregation regions having a maximum dimension of 0.5 μm or more is less than 0.015 per 1 μm² is likely to occur cracks in the cover layer.

Further, Table 1 illustrates that, when the element distribution map of the terminal electrode facing portion is divided into square cells each having a side of 5 μm, the occurrence of cracks in the cover layer due to the concentration of stress from the outside is suppressed in the multilayer ceramic capacitors according to the example in which the number of cells in which the nickel segregation region is included is 50% or more of the total number of cells, whereas the cracks are likely to occur in the cover layer in the multilayer ceramic capacitors according to the comparative example in which the number of cells is less than 50%.

The present specification also discloses the following technique.

### (Supplementary Note 1)

A multilayer ceramic capacitor comprising:
a multilayer chip in which a plurality of dielectric layers formed of a dielectric ceramic and a plurality of internal electrodes composed of a metal as a main component are alternately laminated, the multilayer chip including a plurality of cover layers formed of a dielectric ceramic at both ends of the multilayer chip in a lamination direction;
a plurality of connection conductors formed inside or on a surface of the multilayer chip and that electrically connect the internal electrodes to each other; and
a plurality of terminal electrodes formed on at least one surface of the cover layer with a space therebetween, electrically connected to the connection conductors, respectively, each of the plurality of terminal electrodes including a portion in contact with the cover layers, the portion containing a metal containing nickel as a main component element,
wherein in a case where portions of the cover layers that overlaps the terminal electrodes when viewed from the lamination direction are defined as a plurality of terminal electrode facing portions, and a portion of the cover layers that does not overlap each of the terminal electrodes when viewed from the lamination direction is defined as a terminal electrode non-facing portion,
each of the terminal electrode facing portions has nickel segregation regions each having a maximum dimension of 0.4 μm or more and having a nickel concentration higher than surroundings in an element distribution map generated by measuring a concentration distribution of nickel in any cross section parallel to the lamination direction, and a density of a nickel segregation region having a maximum dimension of 0.5 μm or more in the nickel segregation regions is 0.015 or more per 1 μm², and
in the terminal electrode non-facing portion, a density of the nickel segregation region having the maximum dimension of 0.5 μm or more is 0.008 or less per 1 μm² in the element distribution map.

### (Supplementary Note 2)

The multilayer ceramic capacitor according to Supplementary Note 1, wherein
each of the terminal electrode facing portions has a nickel segregation region having a maximum dimension of 0.7 μm or more in the element distribution map.

### (Supplementary Note 3)

The multilayer ceramic capacitor according to Supplementary Note 1 or 2, wherein
the terminal electrode non-facing portion does not include the nickel segregation region having the maximum dimension of 0.5 μm or more in the element distribution map.

### (Supplementary Note 4)

The multilayer ceramic capacitor according to any one of Supplementary Notes 1 to 3, wherein
each of the terminal electrode facing portions has a nickel diffusion region in which a concentration of nickel decreases with increasing a distance from each of the terminal electrodes, in the vicinity of an interface with each of the terminal electrodes.

### (Supplementary Note 5)

The multilayer ceramic capacitor according to any one of Supplementary Notes 1 to 4, wherein
a thickness of the portion containing the metal containing nickel as the main component element in each of the terminal electrodes is 0.2 μm or more and 1.5 μm or less.

### (Supplementary Note 6)

A multilayer ceramic capacitor comprising:
a multilayer chip in which a plurality of dielectric layers formed of a dielectric ceramic and a plurality of internal electrodes composed of a metal as a main component are alternately laminated, the multilayer chip including a plurality of cover layers formed of a dielectric ceramic at both ends of the multilayer chip in a lamination direction;
a plurality of connection conductors formed inside or on a surface of the multilayer chip and that electrically connect the internal electrodes to each other; and
a plurality of terminal electrodes formed on at least one surface of the cover layer with a space therebetween, electrically connected to the connection conductors, respectively, each of the plurality of terminal electrodes including a portion in contact with the cover layers, the portion containing a metal containing nickel as a main component element,
wherein in a case where portions of the cover layers that overlaps the terminal electrodes when viewed from the lamination direction are defined as a plurality of terminal electrode facing portions, and a portion of the cover layers that does not overlap each of the terminal electrodes when viewed from the lamination direction is defined as a terminal electrode non-facing portion,
in each of the terminal electrode facing portions, when an element distribution map generated by measuring a concentration distribution of nickel in any cross section parallel to the lamination direction is divided into square cells each having a side of 5 μm, a number of cells in which a nickel segregation region having a nickel concentration higher than surroundings and having a maximum dimension of 0.4 μm or more is included is 50% or more of a total number of cells, and
in the terminal electrode non-facing portion, when the element distribution map is divided into the square cells each having a side of 5 μm, a number of cells in which the nickel segregation region is included is 5% or less of the total number of cells.

### (Supplementary Note 7)

The multilayer ceramic capacitor according to Supplementary Note 6, wherein
each of the terminal electrode facing portions has a nickel segregation region having a maximum dimension of 0.7 μm or more in the element distribution map.

### (Supplementary Note 8)

The multilayer ceramic capacitor according to Supplementary Note 6 or 7, wherein
in each of the terminal electrode facing portions, a number of cells in which the nickel segregation region having the maximum dimension of 0.7 μm or more is included is 10% or more of the total number of cells.

### (Supplementary Note 9)

The multilayer ceramic capacitor according to any one of Supplementary Notes 6 to 8, wherein
each of the terminal electrode facing portions has a nickel diffusion region in which a concentration of nickel decreases with increasing a distance from each of the terminal electrodes, in the vicinity of an interface with each of the terminal electrodes.

### (Supplementary Note 10)

The multilayer ceramic capacitor according to any one of Supplementary Notes 6 to 9, wherein
a thickness of the portion containing the metal containing nickel as the main component element in each of the terminal electrodes is 0.2 μm or more and 1.5 μm or less.

### (Supplementary Note 11)

The multilayer ceramic capacitor according to any one of Supplementary Notes 6 to 10, wherein
in each of the terminal electrode facing portions, when the cells are divided into surface layer cells located closer to a surface than a central portion of each of the cover layers in a thickness direction and internal cells located closer to an inside than the central portion of each of the cover layers in the thickness direction, a percentage of the number of cells in which the nickel segregation region is included is higher in the surface layer cells than in the internal cells.

### (Supplementary Note 12)

A method of manufacturing a multilayer ceramic capacitor according to any one of Supplementary Notes 1 to 11, comprising:
preparing a powder of a dielectric ceramic composition;
mixing the powder of the dielectric ceramic composition with a binder and molding a mixture into a sheet shape to obtain a green sheet;
forming an internal electrode pattern including a metal on the green sheet;
laminating a predetermined number of green sheets on which the internal pattern is formed, disposing green sheets for cover layers at both ends of laminated green sheets in a lamination direction, and then pressure-bonding the green sheets for cover layers and the laminated green sheets to obtain an unfired laminated body;
cutting the unfired laminated body to obtain an unfired laminated chip;
removing the binder from the unfired laminated chip;
forming a plurality of metal layers containing nickel as a main component element on a surface of at least one of the green sheets for cover layers in the unfired laminated chip after removal of the binder by a physical vapor deposition method or a thermal spraying method, the plurality of metal layers being spaced from each other; and
firing an unfired molded body on which the plurality of metal layers are formed to obtain a sintered body.

According to the embodiments of the present disclosure, it is possible to a multilayer ceramic capacitor that can suppress the occurrence of cracks in the cover layers due to the concentration of external stress, and can suppress short-circuiting between the terminal electrodes. Such a multilayer ceramic capacitor is useful in that it has high durability and a long life.

The above embodiments are merely examples for carrying out the present disclosure, and the present disclosure is not limited to these embodiments. It is to be understood that the various change, substitutions, and alterations could be made hereto without departing from the spirit and scope of the invention.

What is claimed is:

1. A multilayer ceramic capacitor comprising:
a multilayer chip in which a plurality of dielectric layers formed of a dielectric ceramic and a plurality of internal electrodes composed of a metal as a main component are alternately laminated, the multilayer chip including a plurality of cover layers formed of a dielectric ceramic at both ends of the multilayer chip in a lamination direction;
a plurality of connection conductors formed inside or on a surface of the multilayer chip and that electrically connect the internal electrodes to each other; and
a plurality of terminal electrodes formed on at least one surface of the cover layer with a space therebetween, electrically connected to the connection conductors, respectively, each of the plurality of terminal electrodes including a portion in contact with the cover layers, the portion containing a metal containing nickel as a main component element,
wherein in a case where portions of the cover layers that overlaps the terminal electrodes when viewed from the lamination direction are defined as a plurality of terminal electrode facing portions, and a portion of the cover layers that does not overlap each of the terminal electrodes when viewed from the lamination direction is defined as a terminal electrode non-facing portion,
each of the terminal electrode facing portions has nickel segregation regions each having a maximum dimension of 0.4 μm or more and having a nickel concentration higher than surroundings in an element distribution map generated by measuring a concentration distribution of nickel in any cross section parallel to the lamination direction, and a density of a nickel segregation region having a maximum dimension of 0.5 μm or more in the nickel segregation regions is 0.015 or more per 1 μm², and
in the terminal electrode non-facing portion, a density of the nickel segregation region having the maximum dimension of 0.5 μm or more is 0.008 or less per 1 μm² in the element distribution map.

2. The multilayer ceramic capacitor according to claim 1, wherein
each of the terminal electrode facing portions has a nickel segregation region having a maximum dimension of 0.7 μm or more in the element distribution map.

3. The multilayer ceramic capacitor according to claim 1, wherein
the terminal electrode non-facing portion does not include the nickel segregation region having the maximum dimension of 0.5 μm or more in the element distribution map.

4. The multilayer ceramic capacitor according to claim 1, wherein
each of the terminal electrode facing portions has a nickel diffusion region in which a concentration of nickel decreases with increasing a distance from each of the terminal electrodes, in the vicinity of an interface with each of the terminal electrodes.

5. The multilayer ceramic capacitor according to claim 1, wherein
a thickness of the portion containing the metal containing nickel as the main component element in each of the terminal electrodes is 0.2 μm or more and 1.5 μm or less.

6. A multilayer ceramic capacitor comprising:
a multilayer chip in which a plurality of dielectric layers formed of a dielectric ceramic and a plurality of internal electrodes composed of a metal as a main component are alternately laminated, the multilayer chip including a plurality of cover layers formed of a dielectric ceramic at both ends of the multilayer chip in a lamination direction;
a plurality of connection conductors formed inside or on a surface of the multilayer chip and that electrically connect the internal electrodes to each other; and
a plurality of terminal electrodes formed on at least one surface of the cover layer with a space therebetween, electrically connected to the connection conductors, respectively, each of the plurality of terminal electrodes including a portion in contact with the cover layers, the portion containing a metal containing nickel as a main component element,
wherein in a case where portions of the cover layers that overlaps the terminal electrodes when viewed from the lamination direction are defined as a plurality of terminal electrode facing portions, and a portion of the cover layers that does not overlap each of the terminal electrodes when viewed from the lamination direction is defined as a terminal electrode non-facing portion,
in each of the terminal electrode facing portions, when an element distribution map generated by measuring a concentration distribution of nickel in any cross section parallel to the lamination direction is divided into square cells each having a side of 5 μm, a number of cells in which a nickel segregation region having a nickel concentration higher than surroundings and having a maximum dimension of 0.4 μm or more is included is 50% or more of a total number of cells, and
in the terminal electrode non-facing portion, when the element distribution map is divided into the square cells each having a side of 5 μm, a number of cells in which the nickel segregation region is included is 5% or less of the total number of cells.

7. The multilayer ceramic capacitor according to claim 6, wherein
each of the terminal electrode facing portions has a nickel segregation region having a maximum dimension of 0.7 μm or more in the element distribution map.

8. The multilayer ceramic capacitor according to claim 7, wherein
in each of the terminal electrode facing portions, a number of cells in which the nickel segregation region having the maximum dimension of 0.7 μm or more is included is 10% or more of the total number of cells.

9. The multilayer ceramic capacitor according to claim 6, wherein
each of the terminal electrode facing portions has a nickel diffusion region in which a concentration of nickel decreases with increasing a distance from each of the terminal electrodes, in the vicinity of an interface with each of the terminal electrodes.

10. The multilayer ceramic capacitor according to claim 6, wherein
a thickness of the portion containing the metal containing nickel as the main component element in each of the terminal electrodes is 0.2 μm or more and 1.5 μm or less.

11. The multilayer ceramic capacitor according to claim 6, wherein
in each of the terminal electrode facing portions, when the cells are divided into surface layer cells located closer to a surface than a central portion of each of the cover layers in a thickness direction and internal cells located closer to an inside than the central portion of each of the cover layers in the thickness direction, a percentage of the number of cells in which the nickel segregation region is included is higher in the surface layer cells than in the internal cells.

12. A method of manufacturing the multilayer ceramic capacitor according to claim 1, comprising:
preparing a powder of a dielectric ceramic composition;
mixing the powder of the dielectric ceramic composition with a binder and molding a mixture into a sheet shape to obtain a green sheet;
forming an internal electrode pattern including a metal on the green sheet;
laminating a predetermined number of green sheets on which the internal pattern is formed, disposing green sheets for cover layers at both ends of laminated green sheets in a lamination direction, and then pressure-bonding the green sheets for cover layers and the laminated green sheets to obtain an unfired laminated body;
cutting the unfired laminated body to obtain an unfired laminated chip;
removing the binder from the unfired laminated chip;
forming a plurality of metal layers containing nickel as a main component element on a surface of at least one of the green sheets for cover layers in the unfired laminated chip after removal of the binder by a physical vapor deposition method or a thermal spraying method, the plurality of metal layers being spaced from each other; and
firing an unfired molded body on which the plurality of metal layers are formed to obtain a sintered body.
